(19) United States
(12) Patent Application Publication
(10) Pub. No.: US 2019/0171481 A1
(43) Pub. Date: Jun. 6, 2019

(54) PERFORMING MAINTENANCE TASKS ON COMPOSED SYSTEMS DURING WORKLOAD EXECUTION

(71) Applicant: LENOVO ENTERPRISE SOLUTIONS (SINGAPORE) PTE. LTD., Singapore (SG)

(72) Inventors: FRED A. BOWER, III, DURHAM, NC (US); CAIHONG ZHANG, SHANGHAI (CN)

(21) Appl. No.: 15/832,858

(22) Filed: Dec. 6, 2017

(51) Int. Cl. G06F 9/48; G06F 11/30; G06F 11/34

(52) U.S. Cl. CPC G06F 9/485; G06F 11/3466; G06F 11/3055; G06F 11/3024

(57) ABSTRACT

Performing maintenance tasks on composed systems during workload execution including monitoring a performance of a compute element during the execution of a workload, wherein the compute element is mapped to a composed system executing the workload, and wherein the compute element and the composed system are within a pod of composable compute elements; determining, based on the performance of the compute element, that the compute element has a pending maintenance task; unmapping, from the composed system during the execution of the workload, the compute element with the pending maintenance task; performing the maintenance task on the unmapped compute element during the execution of the workload by the composed system; and remapping the compute element to the composed system during the execution of the workload.

### BACKGROUND

### Field of the Invention

The field of the invention is data processing, or, more specifically, methods, apparatus, and products for performing maintenance tasks on composed systems during workload execution.

### Description of Related Art

In typical computer systems, maintenance tasks often require dedicated control of the hardware being serviced. It is typical to take an entire system offline and dedicate the system to the maintenance task. Performance of these tasks may, consequently, be harder for system administrators to coordinate in a data center environment where system uptime is of paramount importance.

### SUMMARY

Methods, systems, and apparatus for performing maintenance tasks on composed systems during workload execution are disclosed in this specification. Performing maintenance tasks on composed systems during workload execution includes monitoring a performance of a compute element during the execution of a workload, wherein the compute element is mapped to a composed system executing the workload, and wherein the compute element and the composed system are within a pod of composable compute elements; determining, based on the performance of the compute element, that the compute element has a pending maintenance task; unmapping, from the composed system during the execution of the workload, the compute element with the pending maintenance task; performing the maintenance task on the unmapped compute element during the execution of the workload by the composed system; and remapping the compute element to the composed system during the execution of the workload.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for performing maintenance tasks on composed systems during workload execution according to embodiments of the present invention.

FIG. 2 sets forth a block diagram for performing maintenance tasks on composed systems during workload execution according to embodiments of the present invention.

FIG. 3 sets forth a flow chart illustrating an exemplary method for performing maintenance tasks on composed systems during workload execution according to embodiments of the present invention.

FIG. 4 sets forth a flow chart illustrating an exemplary method for performing maintenance tasks on composed systems during workload execution according to embodiments of the present invention.

FIG. 5 sets forth a flow chart illustrating an exemplary method for performing maintenance tasks on composed systems during workload execution according to embodiments of the present invention.

FIG. 6 sets forth a flow chart illustrating an exemplary method for performing maintenance tasks on composed systems during workload execution according to embodiments of the present invention.

FIG. 7 sets forth a flow chart illustrating an exemplary method for performing maintenance tasks on composed systems during workload execution according to embodiments of the present invention.

### DETAILED DESCRIPTION

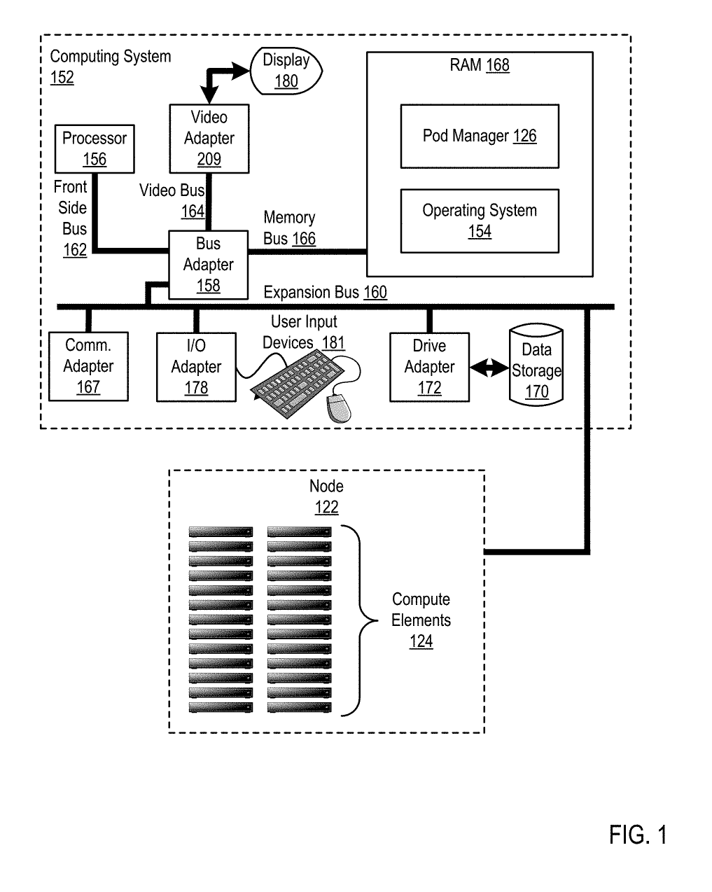

Exemplary methods, apparatus, and products for performing maintenance tasks on composed systems during workload execution in accordance with the present invention are described with reference to the accompanying drawings, beginning with FIG. 1. FIG. 1 sets forth a block diagram of automated computing machinery comprising an exemplary computing system (152) configured for performing maintenance tasks on composed systems during workload execution according to embodiments of the present invention. The computing system (152) of FIG. 1 includes at least one computer processor (156) or ‘CPU’ as well as random access memory (168) (‘RAM’) which is connected through a high speed memory bus (166) and bus adapter (158) to processor (156) and to other components of the computing system (152).

Stored in RAM (168) is an operating system (154). Operating systems useful in computers configured for performing maintenance tasks on composed systems during workload execution according to embodiments of the present invention include UNIX™, Linux™, Microsoft Windows™, AIX™, and others as will occur to those of skill in the art. The operating system (154) in the example of FIG. 1 is shown in RAM (168), but many components of such software typically are stored in non-volatile memory also, such as, for example, on a disk drive (170). Also stored in RAM (168) and part of the operating system is a pod manager (126), a module of computer program instructions for performing maintenance tasks on composed systems during workload execution.

The computing system (152) of FIG. 1 includes disk drive adapter (172) coupled through expansion bus (160) and bus adapter (158) to processor (156) and other components of the computing system (152). Disk drive adapter (172) connects non-volatile data storage to the computing system (152) in the form of disk drive (170). Disk drive adapters useful in computers configured for performing maintenance tasks on composed systems during workload execution according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computing system (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computing system (152) of FIG. 1 includes a communications adapter (167) for data communications with other computers (182) and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for performing maintenance tasks on composed systems during workload execution according to embodiments of the present invention include modems for wired dial-up communications, Ethernet (IEEE 802.3) adapters for wired data communications, and 802.11 adapters for wireless data communications.

The expansion bus (160) of the exemplary computing system (152) of FIG. 1, which may be an interconnect fabric, is also connected to a node (122). The node (122) is a collection of compute elements (124) able to be arranged (i.e., composed) into different configurations based on the data center requirements. The compute elements (124) are modules of computer hardware and software used to create composed systems. The compute modules (124) may be devices that perform one or more functions within a computing system. Examples of compute elements (124) include processing units, memory, communications adapters, I/O adapters, drive adapters, and storage devices such as platter drives and solid state drives. The node (122) may be a set of computing elements configured based on the Rack Scale Design platform. Further, the node (122) may be coupled to the expansion bus (160) via the communications adapter (167).

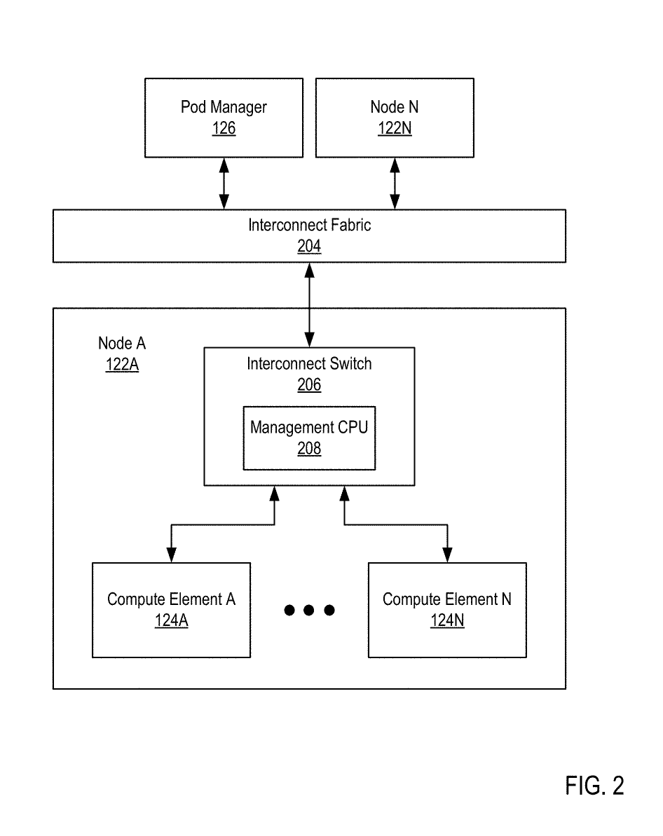

FIG. 2 is an example block diagram of a system configured for performing maintenance tasks on composed systems during workload execution. FIG. 2 includes a pod manager (126) coupled to an interconnected fabric (204). Also, coupled to the interconnect fabric (204) are multiple nodes (node A (122A), node N (122N)). Node A (122A) includes an interconnect switch (206) coupled to the interconnect fabric (204) and multiple compute elements (compute element A (124A), compute element N (124N)). The interconnect switch (206) includes a management central processing unit (CPU) (208). Node N (122N) may include similar elements as those shown in Node A (122A).

A composed system is a collection of compute elements (compute element A (124A), compute element N (124N)) communicatively coupled together (i.e., composed) to form a computing system capable of executing a workload. A composed system may include, for example, compute elements such as a processor, memory, storage, and an I/O controller, each coupled to one another using an interconnect fabric (204). A composed system may include compute elements (compute element A (124A), compute element N (124N)) from different nodes (node A (122A), node N (122N)).

A pod is group of nodes (node A (122A), node N (122N)) housing compute elements (compute element A (124A), compute element N (124N)) used to create composed systems. Each compute element (compute element A (124A), compute element N (124N)) within the pod that is able to be composed into a composed system is referred to as a composable compute element. The pod of composable compute elements includes the composed systems of compute elements. For example, a pod may include three nodes—node A, node B, and node C. Each node may include a processor, memory, storage, and an I/O controller. One composed system may be composed from the processor on node A, the memory and storage on node B, and the I/O controller on node C.

The pod manager (126) is software, hardware, or an aggregation of both software and hardware that composes and manages composed systems. The pod manager (126) manages and configures composed systems made up of compute elements (compute element A (124A), compute element N (124N)) on the nodes (node A (122A), node N (122N)). The pod manager (126) may instruct the management CPU (208) to add or remove a communications coupling on the interconnect fabric (204) between compute elements (compute element A (124A), compute element N (124N)) to create or modify a composed system.

The interconnect fabric (204) is a device or group of devices that transfers data between compute elements (compute element A (124A), compute element N (124N)) and nodes on the system. The interconnect fabric (204) may be a switching fabric such as a Peripheral Component Interconnect Express (PCIe), Infiniband, Omni-Path, or Ethernet network. The interconnect fabric (204) connects to nodes (node A (122A), node N (122N)) via an interconnect switch (206). The interconnect switch (206) is a bridge between the compute elements (compute element A (124A), compute element N (124N)) on the node and the interconnect fabric (204), creating a potential communicative coupling between each compute element (compute element A (124A), compute element N (124N)) on each node (node A (122A), node N (122N)) in the system. Each node (node A (122A), node N (122N)) is a collection of compute elements (compute element A (124A), compute element N (124N)) coupled together via an interconnect switch (206).

The management CPU (208) is software, hardware, or an aggregation of both software and hardware that manages and configures the compute elements (compute element A (124A), compute element N (124N)) on the node. The management CPU (208) communicates with the pod manager (126) to provide the pod manager (126) with information about the compute elements (compute element A (124A), compute element N (124N)) contained within the nodes (node A (122A), node N (122N)). The management CPU (208) also carries out the instructions received from the pod manager (126), including configuring the composition of the composed systems from the compute elements (compute element A (124A), compute element N (124N)) (e.g., by mapping or unmapping compute elements to or from other compute elements).

The management CPU (208) may also monitor the resource utilization of each compute element (compute element A (124A), compute element N (124N)) coupled to the interconnect switch (206). The management CPU (208) may send information about the resource utilization to the pod manager (126). Resource utilization information may include, for example, percentage utilized (e.g., percentage of processor utilization, percentage of storage or memory utilized, etc.), compute element temperature, and I/O generated to and from the compute element.

The compute elements (compute element A (124A), compute element N (124N)) are modules of computer hardware and software used to create composed systems. The compute elements (compute element A (124A), compute element N (124N)) may be endpoints on the interconnect fabric (204). Compute elements (compute element A (124A), compute element N (124N)) may include hardware compute elements such as processors, accelerators, memory, storage, and I/O controllers. Compute elements (compute element A (124A), compute element N (124N)) may also include software compute elements, such as virtualized hardware instantiated to share a single hardware compute element across multiple composed systems.

The compute elements (compute element A (124A), compute element N (124N)) from each node (node A (122A), node N (122N)) make up a resource pool. The resource pool of compute elements is the collection of each compute element (compute element A (124A), compute element N (124N)) from each node (node A (122A), node N (122N)). Each composed system may be composed from a subset of the compute elements (compute element A (124A), compute element N (124N)) in the resource pool.

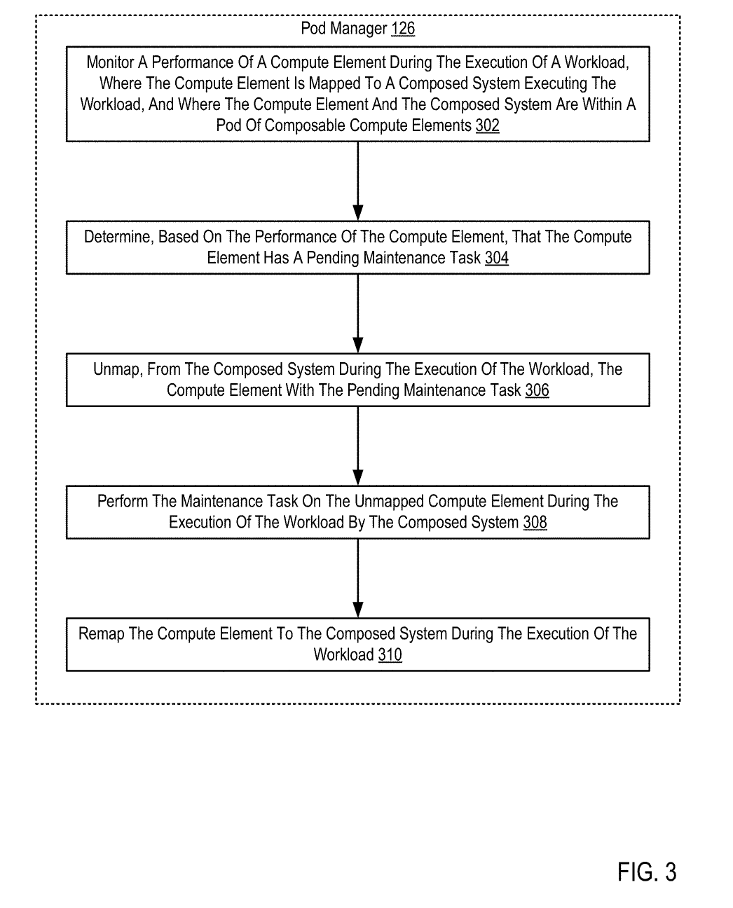

For further explanation, FIG. 3 sets forth a flow chart illustrating an exemplary method for performing maintenance tasks on composed systems during workload execution according to embodiments of the present invention that includes monitoring (302) a performance of a compute element during the execution of a workload, wherein the compute element is mapped to a composed system executing the workload, and wherein the compute element and the composed system are within a pod of composable compute elements. Monitoring (302) a performance of a compute element during the execution of a workload, wherein the compute element is mapped to a composed system executing the workload, and wherein the compute element and the composed system are within a pod of composable compute elements may be carried out by a pod manager or a management CPU receiving information about the state of the compute element as the compute element participates in executing a workload.

A workload is a processing job that includes data and an application in which the data is processed according to the application. For example, a workload may model complex systems, such as weather forecasting using a weather modeling application and weather data. Executing a workload may include contributions from each compute element in the composed system. The involvement of each compute element may increase or decrease depending upon the current requirements of the workload execution. During some periods of the execution of the workload, certain compute elements may be heavily utilized or lightly utilized. Further, during certain periods of the execution of the workload, certain compute elements may be in an idle state.

Monitoring the performance of a compute element may include, for example, measuring a rate of input and or output and comparing the rate to an expected rate, tracking an amount of time elapsed since the beginning of the execution of the workload or since a previous maintenance task was performed, tracking an amount of in-use time of the compute element, and measuring the utilization of the compute element (e.g., average percent capacity utilized over a unit of time).

The pod may be managed and monitored by a pod manager (126) in communication with management CPUs on each node. The pod of composable compute elements may be made up of compute elements on a number of different nodes. The composed system may be made up of a subset of the composable compute elements in the pod, including compute elements on different nodes.

The method of FIG. 3 further includes determining (304), based on the performance of the compute element, that the compute element has a pending maintenance task. Determining (304), based on the performance of the compute element, that the compute element has a pending maintenance task may be carried out by a pod manager or management CPU evaluating the performance of the compute element and, based on the performance, determining that one or more maintenance tasks are to be performed. A maintenance task is an operation performed on a compute element to support the proper operation of the compute element. Examples of maintenance tasks include, for example, firmware updates, diagnostic tests, configuration changes, reformatting, defragmenting, connectivity tests, data cell tests, processing unit tests, verification of outputs such as framerates and bitrates, etc. The maintenance task may be pending in that the maintenance task is targeted to be performed as soon as conditions allow.

For example, the performance of a compute element may be the version of the firmware for the compute element. The management CPU may compare the version of firmware for the compute element to the most recently available version of firmware for the compute element. If the available version of the firmware is greater than the version currently used by the compute element, the management CPU may determine that the compute element has a pending maintenance task for updating the firmware.

As another example, the performance of a solid state storage device may be monitored and the management CPU may determine that the solid state storage device has been in moderate to heavy use for three days, has very high utilization and data replacement rates, and has not undergone an evaluation for bad blocks in the last 24 hours. In response, the management CPU may determine that the compute element has a pending maintenance task for performing an evaluation for bad blocks.

The method of FIG. 3 further includes unmapping (306), from the composed system during the execution of the workload, the compute element with the pending maintenance task. Unmapping (306), from the composed system during the execution of the workload, the compute element with the pending maintenance task may be carried out by disabling a communications coupling on an interconnect fabric between the compute element and the other compute elements in the composed system. Unmapping (306), from the composed system during the execution of the workload, the compute element with the pending maintenance task may also be carried out by rerouting, reflecting, or discarding messages sent to the compute element on the interconnect fabric from the other compute elements in the composed system.

The compute element is unmapped from the other compute elements in the composed system during the execution of the workload. Specifically, the compute element may be unmapped while the other compute elements in the composed system continue to execute the workload. The execution of the workload may continue uninterrupted by the unmapping of the compute element from the other compute elements in the composed system.

Once the pod manager or management CPU determines that the compute element has a pending maintenance task based on the performance of the compute element, the pod manager or management CPU may verify that the compute element has been composed into a composed system. Therefore, the pod manager or management CPU may determine whether the compute element is mapped to a composed system. After the pod manager or management CPU determines that the compute element is mapped to a composed system, the pod manager or management CPU may then unmap the compute element from the composed system.

The method of FIG. 3 further includes performing (308) the maintenance task on the unmapped compute element during the execution of the workload by the composed system. Performing (308) the maintenance task on the unmapped compute element during the execution of the workload by the composed system may be carried out by the management CPU or pod manager proceeding with the steps necessary to complete the maintenance task on the compute element.

The maintenance is performed on the unmapped compute element during the execution of the workload. Specifically, the maintenance is performed on the unmapped compute element while the other compute elements in the composed system continue to execute the workload. The execution of the workload may continue uninterrupted by the maintenance being performed on the unmapped compute element. Further, the workload is executed by the other compute elements in the composed system without the unmapped compute element that is undergoing maintenance.

The method of FIG. 3 further includes remapping (310) the compute element to the composed system during the execution of the workload. Remapping (310) the compute element to the composed system during the execution of the workload may be carried out by enabling a communications coupling on an interconnect fabric between the compute element and the other compute elements in the composed system. Remapping (310) the compute element to the composed system during the execution of the workload may also be carried out by rerouting, messages back to the compute element from the other compute elements in the composed system.

The compute element is remapped to the other compute elements in the composed system during the execution of the workload. Specifically, the compute element may be remapped while the other compute elements in the composed system continue to execute the workload. The execution of the workload may continue uninterrupted by the remapping of the compute element to the other compute elements in the composed system.

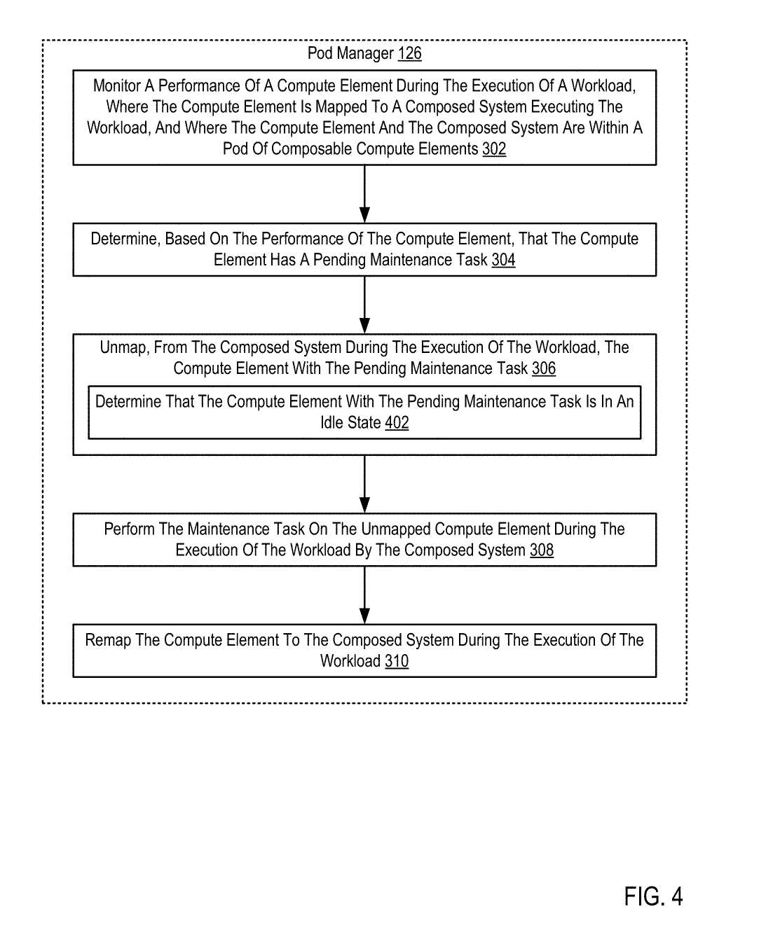

For further explanation, FIG. 4 sets forth a flow chart illustrating a further exemplary method for performing maintenance tasks on composed systems during workload execution according to embodiments of the present invention that includes monitoring (302) a performance of a compute element during the execution of a workload, wherein the compute element is mapped to a composed system executing the workload, and wherein the compute element and the composed system are within a pod of composable compute elements; determining (304), based on the performance of the compute element, that the compute element has a pending maintenance task; unmapping (306), from the composed system during the execution of the workload, the compute element with the pending maintenance task; performing (308) the maintenance task on the unmapped compute element during the execution of the workload by the composed system; and remapping (310) the compute element to the composed system during the execution of the workload.

The method of FIG. 4 differs from the method of FIG. 3, however, in that unmapping (306), from the composed system during the execution of the workload, the compute element with the pending maintenance task includes determining (402) that the compute element with the pending maintenance task is in an idle state. Determining (402) that the compute element with the pending maintenance task is in an idle state may be carried out by the management CPU or pod manager monitoring the utilization of the compute element. Examples of monitoring the utilization of the compute element include, for example, monitoring the communications between the compute element and the other compute elements in the composed system, and monitoring the internal activities of the compute element. Based on the current utilization or utilization pattern of the compute element, the pod manager or management CPU may determine that the compute element is idle and expected to stay idle for a sufficient period of time to perform the maintenance task.

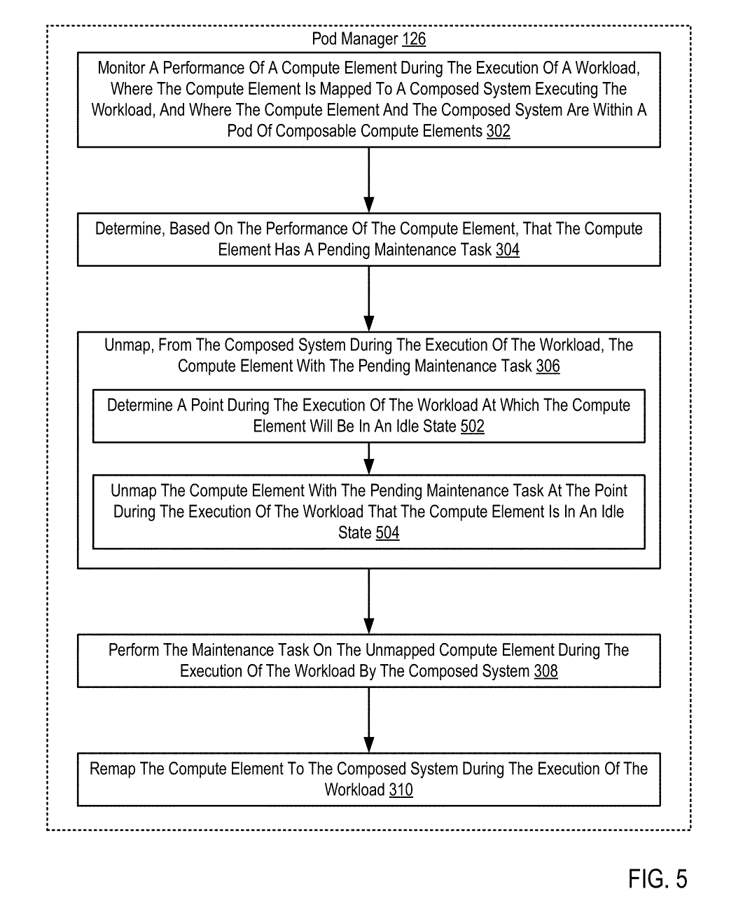

For further explanation, FIG. 5 sets forth a flow chart illustrating a further exemplary method for performing maintenance tasks on composed systems during workload execution according to embodiments of the present invention that includes monitoring (302) a performance of a compute element during the execution of a workload, wherein the compute element is mapped to a composed system executing the workload, and wherein the compute element and the composed system are within a pod of composable compute elements; determining (304), based on the performance of the compute element, that the compute element has a pending maintenance task; unmapping (306), from the composed system during the execution of the workload, the compute element with the pending maintenance task; performing (308) the maintenance task on the unmapped compute element during the execution of the workload by the composed system; and remapping (310) the compute element to the composed system during the execution of the workload.

The method of FIG. 5 differs from the method of FIG. 3, however, in that unmapping (306), from the composed system during the execution of the workload, the compute element with the pending maintenance task includes determining (502) a point during the execution of the workload at which the compute element will be in an idle state; and unmapping (504) the compute element with the pending maintenance task at the point during the execution of the workload that the compute element is in an idle state.

Determining (502) a point during the execution of the workload at which the compute element will be in an idle state may be carried out by evaluating the workload for signals that indicate a future point at which the compute element will be in an idle state for a sufficient period of time to perform the maintenance task. Evaluating the workload may include obtaining a resource model for the workload and assessing, based on the resource model, trigger points that indicate that the compute element will be in an idle state for a sufficient period of time to perform the maintenance task.

Evaluating the workload may also include recognizing patterns of compute element utilization. Specifically, the pod manager or management CPU may monitor and record the utilization of the compute element over time and analyze the record in order to predict a future point at which the compute element will enter an idle state for a sufficient period of time to perform the maintenance task.

Unmapping (504) the compute element with the pending maintenance task at the point during the execution of the workload that the compute element is in an idle state may be carried out by monitoring the workload execution for an indication that the compute element is in or will enter an idle state. The indication may be a trigger point from a resource model or may be part of a recorded pattern of the compute element utilization.

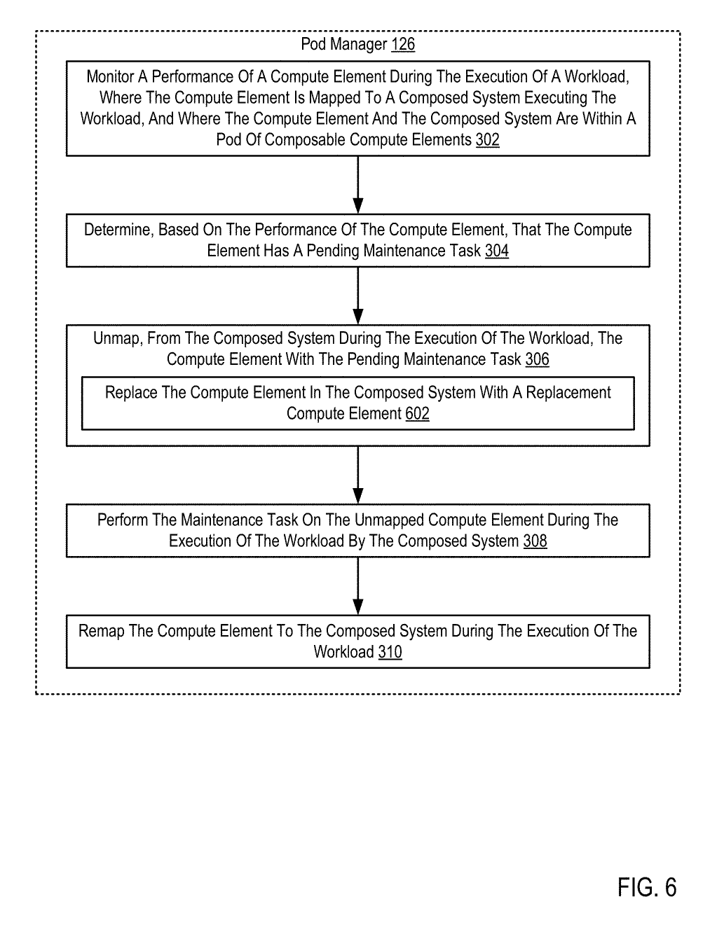

For further explanation, FIG. 6 sets forth a flow chart illustrating a further exemplary method for performing maintenance tasks on composed systems during workload execution according to embodiments of the present invention that includes monitoring (302) a performance of a compute element during the execution of a workload, wherein the compute element is mapped to a composed system executing the workload, and wherein the compute element and the composed system are within a pod of composable compute elements; determining (304), based on the performance of the compute element, that the compute element has a pending maintenance task; unmapping (306), from the composed system during the execution of the workload, the compute element with the pending maintenance task; performing (308) the maintenance task on the unmapped compute element during the execution of the workload by the composed system; and remapping (310) the compute element to the composed system during the execution of the workload.

The method of FIG. 6 differs from the method of FIG. 3, however, in that unmapping (306), from the composed system during the execution of the workload, the compute element with the pending maintenance task includes replacing (602) the compute element in the composed system with a replacement compute element. Replacing (602) the compute element in the composed system with a replacement compute element may be carried out by the pod manager or management CPU locating a similar and available compute element within the composable pod. The management CPU may then map the replacement compute element to the composed system by enabling a communications coupling on an interconnect fabric between the replacement compute element and the other compute elements in the composed system.

The replacement compute element may be located on the same node or a different node from the node containing the compute element undergoing the maintenance task. Further, a list of similar and available compute elements may be compiled by the pod manager or management CPU and a replacement compute element may be selected from the list. The replacement compute element may be selected from the list based on the proximity between the other compute elements in the composed system and the potential replacement elements.

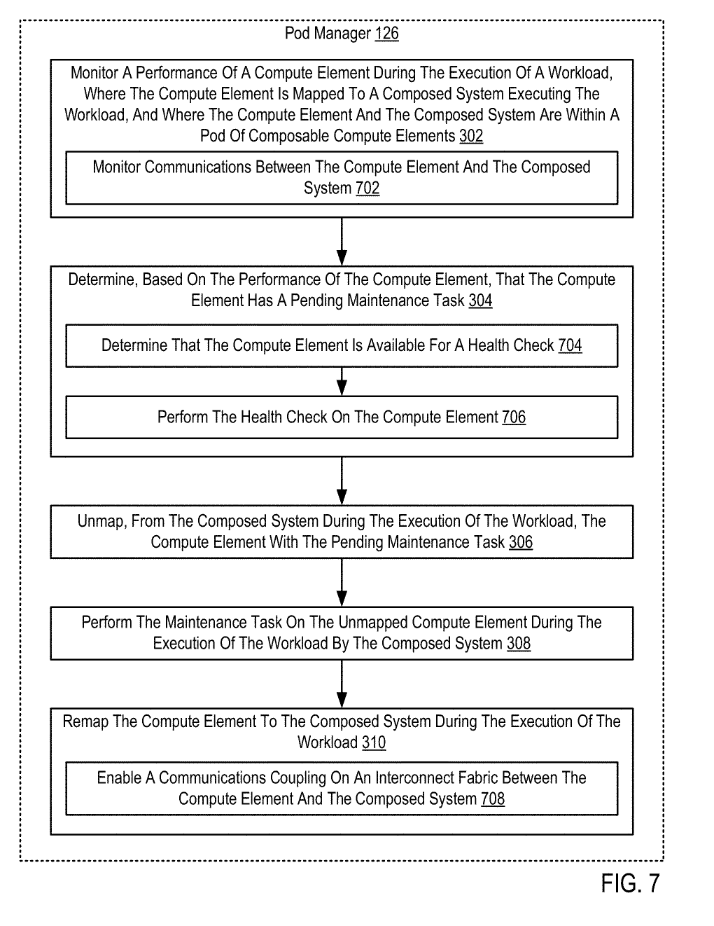

For further explanation, FIG. 7 sets forth a flow chart illustrating a further exemplary method for performing maintenance tasks on composed systems during workload execution according to embodiments of the present invention that includes monitoring (302) a performance of a compute element during the execution of a workload, wherein the compute element is mapped to a composed system executing the workload, and wherein the compute element and the composed system are within a pod of composable compute elements; determining (304), based on the performance of the compute element, that the compute element has a pending maintenance task; unmapping (306), from the composed system during the execution of the workload, the compute element with the pending maintenance task; performing (308) the maintenance task on the unmapped compute element during the execution of the workload by the composed system; and remapping (310) the compute element to the composed system during the execution of the workload.

The method of FIG. 7 differs from the method of FIG. 3, however, in that monitoring (302) a performance of a compute element during the execution of a workload, wherein the compute element is mapped to a composed system executing the workload, and wherein the compute element and the composed system are within a pod of composable compute elements includes monitoring (702) communications between the compute element and the composed system. Monitoring communications between the compute element and the composed system may be carried out by measuring the I/O messages on the communications fabric between the compute element and the other compute elements in the composed system. The measurement may be, for example, a rate at which messages are sent or received by the compute element, or the types of I/O messages sent or received by the compute element.

The method of FIG. 7 also differs from the method of FIG. 3 in that determining (304), based on the performance of the compute element, that the compute element has a pending maintenance task includes determining (704) that the compute element is available for a health check. Determining (704) that the compute element is available for a health check may be carried out by the management CPU or pod manager monitoring the utilization of the compute element. Based on the current utilization or utilization pattern of the compute element, the pod manager or management CPU may determine that the compute element is available for a health check and expected to stay available for a sufficient period of time to perform the health check.

Performing (706) the health check on the compute element may be carried out by gathering diagnostic information for the compute element and comparing the diagnostic information to expected diagnostic information. Based on the comparison, the pod manager or management CPU may determine that the compute element has a pending management task. For example, the pod manager or management CPU may boot a diagnostic program and run the diagnostic program using the processors, memory, and other system resources to execute the diagnostic program.

The method of FIG. 7 also differs from the method of FIG. 3 in that remapping (310) the compute element to the composed system during the execution of the workload includes enabling (708) a communications coupling on an interconnect fabric between the compute element and the composed system. Enabling (708) a communications coupling on an interconnect fabric between the compute element and the composed system may be carried out by the management CPU creating or recreating a communications path on the interconnect fabric to allow communications between the compute element and the other compute elements in the composed system.

In view of the explanations set forth above, readers will recognize that the benefits of performing maintenance tasks on composed systems during workload execution according to embodiments of the present invention include:
Improving the operation of a computing system by performing maintenance without requiring the workload to be involved or aware of the activity, increasing computing system efficiency and reliability.
Improving the operation of a computing system by performing maintenance with minimal overhead in terms of hardware and software, increasing computing system efficiency.
Improving the operation of a computing system by minimizing system operation interruption without a high degree of internal redundancy, increasing computing system functionality and efficiency.

Exemplary embodiments of the present invention are described largely in the context of a fully functional computer system for performing maintenance tasks on composed systems during workload execution. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method comprising:
by program instructions on a computing device,
monitoring a performance of a compute element during the execution of a workload, wherein the compute element is mapped to a composed system executing the workload, and wherein the compute element and the composed system are within a pod of composable compute elements;
determining, based on the performance of the compute element, that the compute element has a pending maintenance task;
unmapping, from the composed system during the execution of the workload, the compute element with the pending maintenance task;
performing the maintenance task on the unmapped compute element during the execution of the workload by the composed system; and
remapping the compute element to the composed system during the execution of the workload.

2. The method of claim 1, wherein unmapping the compute element with the pending maintenance task from the composed system during the execution of the workload comprises determining that the compute element with the pending maintenance task is in an idle state.

3. The method of claim 1, wherein unmapping the compute element with the pending maintenance task from the composed system during the execution of the workload comprises:
determining a point during the execution of the workload in which the compute element will be in an idle state; and
unmapping the compute element with the pending maintenance task at the point during the execution of the workload that the compute element is in an idle state.

4. The method of claim 1, wherein unmapping the compute element with the pending maintenance task from the composed system during the execution of the workload comprises replacing the compute element in the composed system with a replacement compute element.

5. The method of claim 1, wherein remapping the compute element to the composed system during the execution of the workload comprises enabling a communications coupling on an interconnect fabric between the compute element and the composed system.

6. The method of claim 1, wherein determining, based on the performance of the compute element, that the compute element has the pending maintenance task comprises:
determining that the compute element is available for a health check; and
performing the health check on the compute element.

7. The method of claim 1, wherein monitoring the performance of the compute element during the execution of the workload comprises monitoring communications between the compute element and the composed system.

8. An apparatus comprising a computing device, a computer processor, and a computer memory operatively coupled to the computer processor, the computer memory having disposed within it computer program instructions that, when executed by the computer processor, cause the apparatus to carry out the steps of:
monitoring a performance of a compute element during the execution of a workload, wherein the compute element is mapped to a composed system executing the workload, and wherein the compute element and the composed system are within a pod of composable compute elements;
determining, based on the performance of the compute element, that the compute element has a pending maintenance task;
unmapping, from the composed system during the execution of the workload, the compute element with the pending maintenance task;
performing the maintenance task on the unmapped compute element during the execution of the workload by the composed system; and
remapping the compute element to the composed system during the execution of the workload.

9. The apparatus of claim 8, wherein unmapping the compute element with the pending maintenance task from the composed system during the execution of the workload comprises determining that the compute element with the pending maintenance task is in an idle state.

10. The apparatus of claim 8, wherein unmapping the compute element with the pending maintenance task from the composed system during the execution of the workload comprises:
determining a point during the execution of the workload in which the compute element will be in an idle state; and
unmapping the compute element with the pending maintenance task at the point during the execution of the workload that the compute element is in an idle state.

11. The apparatus of claim 8, wherein unmapping the compute element with the pending maintenance task from the composed system during the execution of the workload comprises replacing the compute element in the composed system with a replacement compute element.

12. The apparatus of claim 8, wherein remapping the compute element to the composed system during the execution of the workload comprises enabling a communications coupling on an interconnect fabric between the compute element and the composed system.

13. The apparatus of claim 8, wherein determining, based on the performance of the compute element, that the compute element has the pending maintenance task comprises:
determining that the compute element is available for a health check; and
performing the health check on the compute element.

14. The apparatus of claim 8, wherein monitoring the performance of the compute element during the execution of the workload comprises monitoring communications between the compute element and the composed system.

15. A computer program product including a computer readable medium, the computer program product comprising computer program instructions that, when executed, cause a computer to carry out the steps of:
monitoring a performance of a compute element during the execution of a workload, wherein the compute element is mapped to a composed system executing the workload, and wherein the compute element and the composed system are within a pod of composable compute elements;
determining, based on the performance of the compute element, that the compute element has a pending maintenance task;
unmapping, from the composed system during the execution of the workload, the compute element with the pending maintenance task;
performing the maintenance task on the unmapped compute element during the execution of the workload by the composed system; and
remapping the compute element to the composed system during the execution of the workload.

16. The computer program product of claim 15, wherein unmapping the compute element with the pending maintenance task from the composed system during the execution of the workload comprises determining that the compute element with the pending maintenance task is in an idle state.

17. The computer program product of claim 15, wherein unmapping the compute element with the pending maintenance task from the composed system during the execution of the workload comprises:
determining a point during the execution of the workload in which the compute element will be in an idle state; and
unmapping the compute element with the pending maintenance task at the point during the execution of the workload that the compute element is in an idle state.

18. The computer program product of claim 15, wherein unmapping the compute element with the pending maintenance task from the composed system during the execution of the workload comprises replacing the compute element in the composed system with a replacement compute element.

19. The computer program product of claim 15, wherein remapping the compute element to the composed system during the execution of the workload comprises enabling a communications coupling on an interconnect fabric between the compute element and the composed system.

20. The computer program product of claim 15, wherein determining, based on the performance of the compute element, that the compute element has the pending maintenance task comprises:
determining that the compute element is available for a health check; and
performing the health check on the compute element.
